(19) United States
(12) Patent Application Publication
(10) Pub. No.: US 2013/0269432 A1
(43) Pub. Date: Oct. 17, 2013

(54) Electromechanical Fill-Level Measuring Device

(71) Applicants: Wolfgang Brutschin, Schopfheim (DE); Andreas Kaiser, Yamanashi (JP); Carmen Sawitzki, Schopfheim (DE); Keita Okazaki, Yamanashi (DE)

(72) Inventors: Wolfgang Brutschin, Schopfheim (DE); Andreas Kaiser, Yamanashi (JP); Carmen Sawitzki, Schopfheim (DE); Keita Okazaki, Yamanashi (DE)

(21) Appl. No.: 13/977,158

(22) PCT Filed: Dec. 22, 2011
(86) PCT No.: PCT/EP2011/073879

§ 371 Date: Jun. 28, 2013

(30) Foreign Application Priority Data
Dec. 31, 2010 (DE) 10 2010 056 511.3

(51) Int. Cl. G01F 23/44

(52) U.S. Cl. CPC G01F 23/44
USPC 73/313

(57) ABSTRACT

An electromechanical, fill-level, measuring device, comprising: a float, an outer drum with an outer ring of magnets, an inner drum with an inner ring of magnets, electromagnetic measuring elements, a measuring shaft with, and a servomotor with an drive shaft. The drive shaft is coupled with the measuring shaft via a transmission, wherein the servomotor rotates the measuring shaft via the transmission as a function of a control signal ascertained from the difference value of the measuring elements, so that, by relative movement between the outer and inner drums produced by a change of the liquid level to be measured, the difference value is returned to zero and from the rotation of the measuring shaft the current fill level measured value is ascertained. Sensor electronics is arranged on the measuring shaft within the inner drum, and radial, rotary transformer is embodied on the measuring shaft for transmitting at least the control signals from the sensor electronics to the main electronics and supplying for at least the sensor electronics with energy.

The invention relates to an electromechanical fill-level measuring device, including a float, or displacement element, which is suspended by means of a wire and which floats on a liquid whose level is to be measured, an outer drum with an outer ring of magnets, an inner drum with an inner ring of magnets and electromagnetic measuring elements, which ascertain magnetic field displacement between the inner and outer ring of magnets and output a measured value, a measuring shaft, with which the inner drum is mechanically fixedly connected, wherein a servomotor with an drive shaft is provided, wherein the drive shaft is coupled with the measuring shaft via a transmission, wherein the servomotor rotates the measuring shaft via the transmission as a function of a control signal ascertained from the difference value of the electromagnetic measuring elements, so that, by the relative movement between the outer and inner drums produced by a change of the liquid level to be measured, the difference value is returned to zero and from the rotation of the measuring shaft the current fill level measured value is ascertained.

Methods and apparatuses for fill level measurement working according to the sounding principle are generally known. For example, DE 21 51 094, DE 24 01 486 B2, DE 819 923, DE 39 42 239 A1, US 3,838,518, DE 195 43 352 A1, G 70 31 884.2, DE 819 923, G 73 29 766.2, DE 19730196 A1, as well as DE 28 53 360 A1 describe fill level measuring systems for highly accurate fill level determination working according to the sounding principle. In the case of these methods of fill level measurement based on the sounding principle, a plumb bob hanging on a measuring line sinks onto the fill substance, or bulk good. Upon striking the fill substance, the length of the measuring cable wound off the cable drum is ascertained and a display device displays the fill level, or the fill quantity. Different fill substances require different plumb bobs.

The main field of application of electromechanical sounding is fill level measurement in the case of very high containers, where solutions using other measuring principles are very costly or, for physical reasons, not possible. With electromechanical sounding, fill levels in containers of, currently, up to, for instance, 70 m height are measurable with an accuracy of under one millimeter.

A method for fill level measurement according to the sounding principle, wherein the cable drum and the drive shaft of an electric motor are resiliently coupled with one another, and wherein the fill level is determined by counting in a counting system the pulses produced when winding the cable drum, is described in DE 31 49 220 A1 of the assignee. In this measuring method, the striking of the displacement element on the fill substance is detected advantageously without the actuation of mechanical switching elements. Moreover, in the case of such measuring method, it is no longer necessary to monitor the electrical input variables of the electric motor. Since the sensor is arranged outside of the space intended for the fill substance, its construction is not subject to the requirements holding for the container interior. This means that, for the majority of fill substances, sensors with lesser shielding can be applied. This is achieved by the fact that the cable drum and the drive shaft connected with the electric motor are, thanks to the resilient coupling, arranged rotatably relative to one another between two end positions over a limited angular range. The cable drum and the drive shaft of the electric motor are, in each case, rigidly coupled with pulse emitter disks, which are sampled by contactless sensors. When the plumb bob strikes the surface of the fill substance, tensile stress in the measuring line brought about by the weight of the plumb bob disappears.

Other apparatuses for liquid level measuring and density determination according to the displacement measuring principle are known from DE 37 21164 A1, DE 2853360 A1, DE 2401486 B2 and DE 2659416 A1.

Known from DE 2853360 A1 is a liquid level meter having a displacement body. This displacement body is provided with a wire, which can be wound on, or fed off from, a drum. The drum is driven by a shaft with the assistance of a motor, wherein a system for ascertaining the change of torque exerted on the shaft is provided.

Described in DE 2659416 A1 is an apparatus for measuring a liquid level, in the case of which the change of the liquid level is converted into a rotational movement. Furthermore, a magnetic head is provided on an arm. The magnetic head rotates corresponding to the change of the liquid level and, in such case, samples magnetic fields, which are brought about by electrical conductors arranged on the periphery of a disk.

DE 2401486 B2 discloses a fill level display device working according to the displacement measuring principle, in the case of which a cable is wound on or off a drum, wherein a counting disk is rotated and, in such case, a continued series of pulses is produced via a protective gas protected, contact switch, in order to provide a measure of the fed cable length.

Known from DE 37 21164 A1 is a fill-level, measuring device, which contains a float and a wire. The float floats on the surface of a liquid (not shown). The wire is wound on a drum and can be wound up on this drum or fed off from it. Connected with the floor of the drum is a measuring shaft. If the liquid level changes, on which the float floats, then there changes therewith also the tension exerted by the wire on the drum. This change of the tension exerted by the wire is converted via an outer ring of magnets acting as a coupling part into a measuring shaft torque. The cylindrical, outer ring of magnets is connected with the floor in the interior of the drum. Magnetic poles, south- and north poles, are arranged alternately in the circumferential direction of the outer ring of magnets. Alternately embodied on the inner ring of magnets connected with the measuring shaft are magnetic north- and south poles in equal number as on the outer ring of magnets. An electromagnetic transducer, e.g. a Hall element, is arranged on the outer periphery of the inner ring of magnets in the interfacial region between different magnetic poles. If in the case of a change of the liquid level to be measured a force is produced, which causes a relative movement between the outer and inner rings of magnets, then a change of the magnetic flux present between the outer and inner rings of magnets produces in the electromagnetic transducer an electrical signal, by which the measuring shaft is so rotated that the relative movement between the inner and outer ring of magnets is returned to zero and, in such case, a measured value of the achieved liquid level is won. Via a sliding contact located on the measuring shaft, the electrical signal of the electromagnetic transducer in the inner drum is transmitted to the servomotor control. This mechanical tapping has the disadvantage that it does not occur wear-free and frictional resistances produce a torque change, so that measurement inaccuracies can occur.

An object of the invention is to provide an apparatus for fill level measurement working according to the displacement measuring principle, which is distinguished by simple construction and low manufacturing costs, and improves mechanical measuring sensitivity and accuracy of measurement.

The object is achieved by an electromechanical, fill-level, measuring device, including a float, or displacement element, which is suspended by means of a wire and which floats on a liquid whose level is to be measured, an outer drum with an outer ring of magnets, an inner drum with an inner ring of magnets and electromagnetic measuring elements, which ascertain magnetic field displacement between the inner and outer rings of magnets and output a measured value, a measuring shaft, with which the inner drum is mechanically fixedly connected, wherein a servomotor with an drive shaft is provided, wherein the drive shaft is coupled with the measuring shaft via a transmission, wherein the servomotor rotates the measuring shaft via the transmission as a function of a control signal ascertained from a difference value of the electromagnetic measuring elements, so that, by relative movement between the outer and inner drums produced by a change of the liquid level to be measured, the difference value is returned to zero and from the rotation of the measuring shaft the current fill level measured value is ascertained, wherein a sensor electronics is arranged on the measuring shaft within the inner drum and ascertains the control signal at least from the difference value of the electromagnetic measuring elements, and that a radial, rotary transformer is embodied on the measuring shaft for transmitting at least the control signals from the sensor electronics to the main electronics and for supplying at least the sensor electronics with energy.

In an advantageous embodiment of the invention, is the radial, rotary transformer is embodied by a bifilar wound, primary winding and a bifilar wound, secondary winding.

In a further development of the invention, the transmission of the control signal and/or communication signals between the sensor electronics and a main electronics is performed digitally via the radial, rotary transformer by means of frequency shift modulation.

In an advantageous, further development, energy supply of the sensor electronics is by means of rectification of an alternating signal fed via the radial, rotary transformer.

In an advantageous embodiment of the invention, evaluating the difference values of the electromagnetic measuring elements and calculating the control signal are performed in the sensor electronics and digital transmission is provided via the rotary transformer.

In an additional embodiment, the sensor electronics includes at least one secondary demodulator, one secondary modulator and one voltage supply unit.

In a further embodiment, the main electronics includes at least one primary demodulator, one primary modulator and one oscillator.

In a special embodiment, the primary modulator and the oscillator are integrated and/or embodied in a microprocessor of the main electronics.

In an advantageous further development, is the primary demodulator is embodied in the main electronics as a counter.

In a further development, the primary modulator of the main electronics is embodied as a push pull end stage, which is embodied with the radial, rotary transformer and the push-pull amplifier as a push pull converter.

In a special embodiment, is the secondary demodulator is embodied in the sensor electronics at least as an oscillatory circuit with a comparator.

In a supplementing embodiment, the voltage supply unit in the sensor electronics includes at least one rectification element and at least one linear regulator.

Other details, features and advantages of the subject matter of the invention will become evident from the following description with the associated drawing, in which preferred examples of embodiments of the invention are presented. In the examples of embodiments of the invention shown in the figures, for better overview and for simplification, elements, which correspond in construction and/or in function, are provided with equal reference characters. The figures of the drawing show as follows:

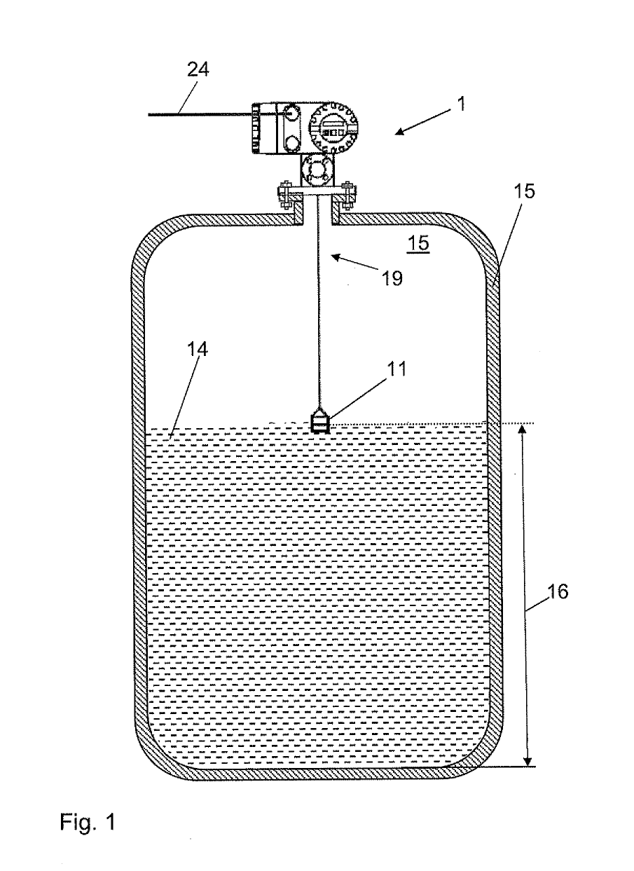

FIG. 1 an example of an embodiment of a measuring device for ascertaining fill level working according to the displacement measuring principle,

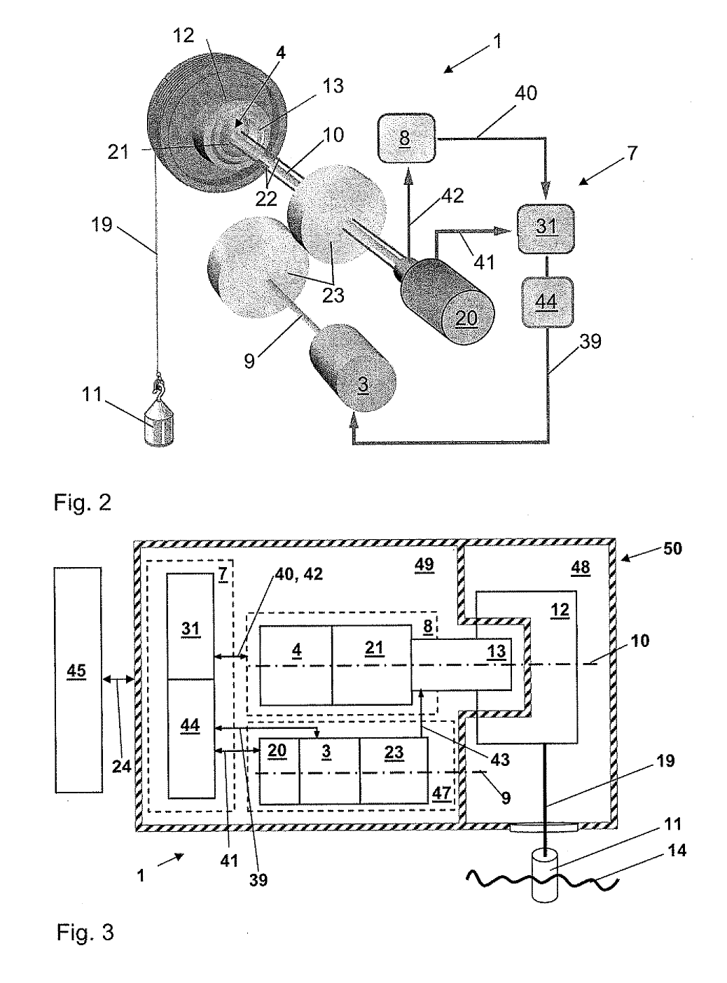

FIG. 2 a schematic drawing of an electromechanical, fill-level, measuring device,

FIG. 3 a schematic drawing of the electromechanical, fill-level, measuring device of the invention,

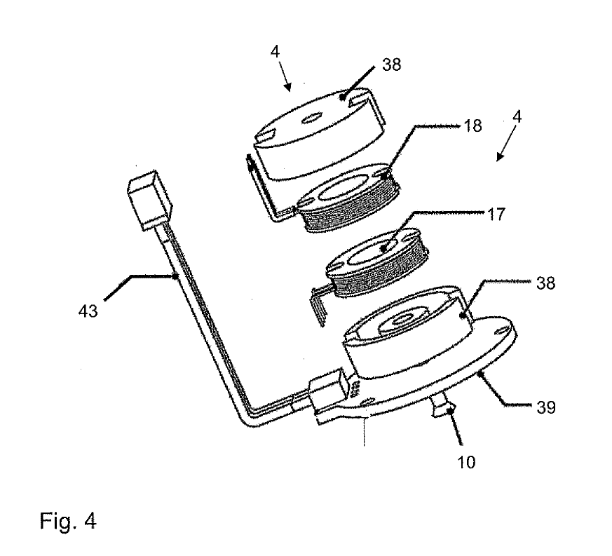

FIG. 4 a view of the radial, rotary transformer of the invention, and

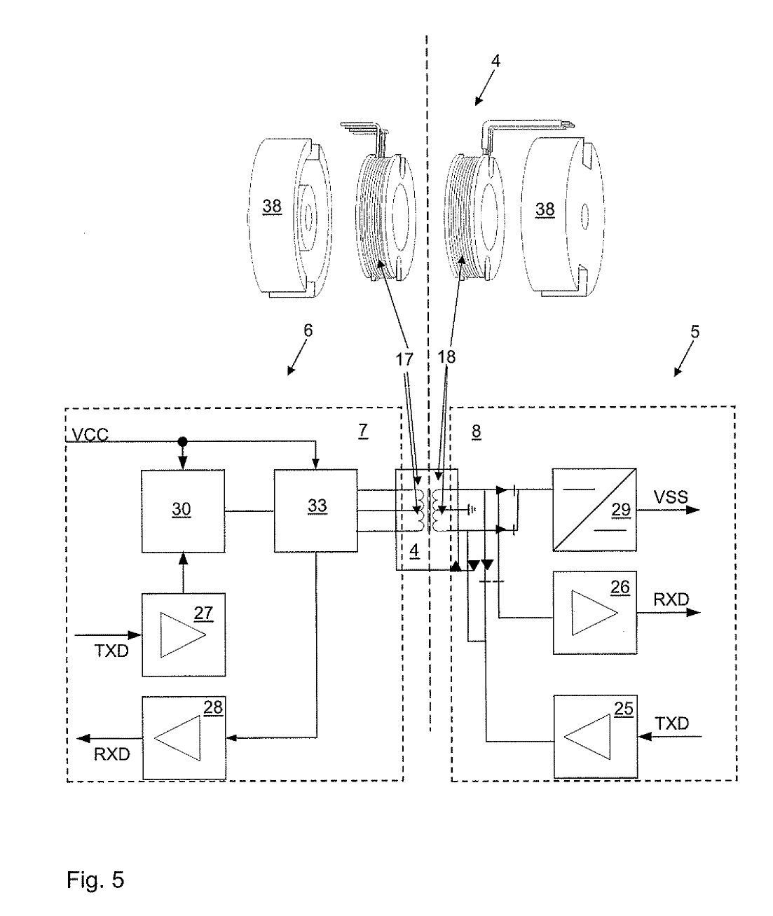

FIG. 5 a schematic drawing of the modulation- and demodulation circuits for transmission of data and energy via the rotary transformer of the invention.

FIG. 1 shows a mechanical fill-level measuring device 1, which is, for example, the tank measuring system, PROSERVO NMS 53× tank gauge, of the assignee and is based on the principle of displacement measurement using a small displacement element 11 suspended on a measuring line 19 and positioned with the assistance of a servomotor 3 (FIG. 2) precisely in the liquid 14 in the container 15. As soon as the fill level 16 of the liquid 14 in the container 15 rises or falls, the position of the displacement element 11 is adjusted by the servomotor 3 by rotating the measuring shaft 10 with the measurement drum 12, 13. The rotation of the measurement drum 12, 13 is evaluated, in order to ascertain the fill level 16. Also, the ascertaining of further measured variables, such as separation layer- and density measurement of the individual layers of the fill substance 14, can be performed with this measuring principle.

In modern industrial plants, field devices are, as a rule, connected via bus systems 24, such as, for example, via Profibus® PA, Foundation Fieldbus® or HART® bus systems, with at least one superordinated control unit, which is not explicitly shown here. The data communication controlled by the control unit on the bus system 24 can occur both via wire as well as also wirelessly. Normally, the superordinated control unit is a PLC (programmable logic controller) or a DCS (distributed control system). The superordinated control unit serves for process control, for process visualizing, for process monitoring as well as for start-up and servicing of the field devices.

A SCADA software (supervisory control and data acquisition) in the control unit, for monitoring and control unit of processes, calculates, for example, the mass of the liquid- and gas phase of liquified gases as fill substance 14 from the measured values of fill level, pressure, temperature and, naturally, density. The fill level measured via the Proservo tank gauge is output, for example, on a fieldbus 24 and read in, for example, using an Endress+Hauser fieldbus interface (RTU 8130). The other process data, pressure and temperature, are fed via the OPC client/server interface into the monitoring system. After the data are calculated there, they are ready to be used by the control system.

FIG. 2 shows a fill-level measuring device 1, which works according to the displacer principle using a displacement element, respectively float, 11. The displacement element, respectively float, 11 is secured on an end of a measurement cable, respectively measurement wire, 19 and the other end of the measurement cable 19 is, most often, wound as one ply on an outer cable drum 12, respectively outer measurement drum 12.

A small displacement element 11 is positioned with the assistance of a small servomotor 3 precisely in the liquid, respectively the liquid fill substance, 14. The displacement element 11 hangs on a measurement wire, respectively cable, 19, which is wound with one ply (so that the winding diameter remains equal) on a measurement drum, respectively outer cable drum, 12 equipped with fine grooves and located in the interior of the measuring device 1. The outer cable drum 12 is coupled, for example, via coupling magnets, with the inner cable drum 13. The two drums are spatially isolated from one another completely and hermetically sealedly by the drum housing 48. The outer magnets are connected with the outer cable drum 12 and the inner magnets with the inner cable drum 13. When the inner magnets rotate, the magnetic attractive force causes the outer magnets to follow, so that the entire drum assembly composed of outer cable drum 12 and inner cable drum 13 rotates on the measuring shaft 10.

When the magnets with the inner cable drum 13 rotate, the magnetic attractive force causes the outer magnets on the outer cable drum 12 to follow, so that the entire drum assembly rotates. From the weight of the displacement element 11 on the measurement wire 19, a torque acts on the outer magnets, whereby a change of magnetic flux results. These magnetic field changes acting between the components of the measuring drums 12, 13 are registered by a special electromagnetic measuring transducer 21, e.g. a Hall sensor, on the inner measurement drum 13. The measuring transducer signal 42 of the measuring transducer 21 is led via sensor signal lines 22 along the measuring shaft 10 to a sliding contact on the other side of the transmission 23, where the measuring transducer signal 42 is further processed by the sensor electronics 8 into a weight measurement signal 40. This weight measurement signal 40 is evaluated with the position data signal 41 of an encoder 20 located on the measuring shaft 10 by a microprocessor 31 in the main electronics 7 and a corresponding motor control signal 39 transmitted to the drive motor 3. The drive motor 3 is so operated by the motor control signal 39 that the voltage produced by the changes of the magnetic flux in the measuring transducer 21 is adjusted to the voltage predetermined by the activation command. When the displacement element 11 sinks and sits upon the surface of the liquid 14, the weight of the displacement element 11 is reduced by the buoyant force of the liquid 14. In this way, the torque changes in the magnetic coupling between the outer cable drum 12 and the inner cable drum 13. This change is measured, for example, by five temperature compensated Hall detector chips as measuring element 21. The position data signal 41, which represents the position of the displacement element 11, is transmitted to the motor control electronics 44 in the main electronics 7, e.g. a microprocessor 31. As soon as the level of the liquid 14 rises or falls, the position of the displacement element 11 is adjusted by the drive motor 3 by means of a transmission 23. The rotation the measurement drum 12 is exactly evaluated, in order to ascertain the fill level value 16 exactly to within +/−0.7 mm.

This embodiment of an electromechanical, fill-level, measuring device 1 with a sliding contact located on the measuring shaft 10 for transmission of the electrical measuring transducer signal 42 of the electromagnetic measuring transducer 21 in the inner cable drum 13 to the main electronics 7, especially to the sensor electronics 8 with the servomotor control 44, has the disadvantage that the mechanical tapping of the measuring transducer signal 42 via the sliding contacts is not wear-free and produces through the frictional resistances a torque change and, thus, can lead to measurement inaccuracies.

FIG. 3 shows the fill-level measuring device 1 of the invention with a rotary transformer 4. The housing 50 of the fill-level measuring device 1 of the invention is likewise divided hermetically sealedly into a drum housing, or drum space, 48 and an electronics compartment 49. Located in the drum space 48 is an outer cable drum 12 seated on a measuring shaft 10. Cable drum 12 has on its surface fine grooves, into which a measurement wire 19 is wound with one ply, such that the winding diameter always remains the same. The outer cable drum 12 is coupled with the inner cable drum 13 magneto-mechanically via coupling magnets acting through the wall of the drum housing 48. The outer magnets are connected with the outer cable drum 12 and the inner magnet with the inner cable drum 13, which is located in the electronics compartment 49 seated on the measuring shaft 10. The measuring shafts 10 of the outer cable drum 12 and the inner cable drum 13 are separated from one another but lie exactly on the same axis of rotation. When the magnets rotate, the magnetic attraction force of the outer magnets of the outer cable drum 12 cause the inner cable drum 13 to follow, so that the entire drum assembly composed of outer cable drum 12 and inner cable drum 13 rotates on the same axis of rotation of the two measuring shafts 10. When the position of the displacement element 11 changes due to a change of the level of the liquid 14, the torque in the magnetic coupling between the outer cable drum 12 and the inner cable drum 13 changes. This change is measured as measuring transducer signal 42, for example, by five temperature-compensated, Hall-detector chips as measuring element 21 in the inner drum. This measuring transducer signal 42 is transmitted from the sensor electronics 8 via the rotary transformer 4 of the invention to the main electronics 7, especially the microprocessor 31, as a weight measurement signal 40.

Due to the good transmission characteristics of the radial, rotary transformer 4 of the weight measurement signal 40 and, in the opposite direction, the opportunity for reliable energy supply of the sensor electronics 8 from the main electronics 8, an option is to place the sensor electronics 8 directly within the inner cable drum 13 near to the measuring element 21. This enables a more exact evaluation of the measuring elements 21, especially the Hall sensors, and a preprocessing of the measured values of the measuring elements 21. It is also possible to integrate a microprocessor 31 in the sensor electronics 8 in the inner cable drum 13, so that the tasks of operating the drive motor 3 using a motor control signal 39, the calibrating of the Hall sensors, and even the ascertaining of the fill level 16 can occur directly in the sensor electronics 8.

Mounted on the drive shaft 9 in the electronics compartment 49 is a drive unit 47 with at least one drive motor 3, at least one transmission 23 and at least one encoder 20. Via a motor control signal 39 of the motor control electronics 44 in the main electronics 7, the drive motor 3 is operated and drives via the transmission 23 by means of a driving force 43 either directly the inner cable drum 13 or the measuring shaft 10 with the thereon located, inner cable drum 13. Encoder 20 ascertains the rotational movement and transmits this as position data signal, or rotary movement signal, 41 back to the motor control 44 in the main electronics 7 for checking or control. The fill-level measuring device 1 is connected via a fieldbus 24 with a control station 45 and communicates the fill level 16 to the control station 45.

FIG. 4 shows the fill-level measuring device 1 of the invention with a rotary transformer 4 having a primary winding 17 and a secondary winding 18. The primary side 6 of the radial, rotary transformer 4, with its primary winding 17, can rotate mechanically freely relative to the secondary side 7 with its secondary winding 18. The rotary transformer 4 is composed of a secondary winding 18 as stator and a primary winding 17 as rotor rotating on the measuring shaft 10. Serving for guiding the magnetic flux between the two windings, such as in the case of a conventional transformer, is a two-part, ferrite core 38, which surrounds the windings.

The radial, rotary transformer 4 is used in the fill-level measuring device 1 of the invention for signal transmission between the measuring elements 21, respectively sensor electronics 8, and the main electronics 7, as well as also in the opposite direction for energy supply of the sensor electronics 8 from the main electronics 7. The primary winding 17 and the secondary winding 18 are separated from one another by an air gap of about 0.3 mm, whereby very good signal- and energy transmission can occur across the rotary transformer.

FIG. 5 shows the modulation- and demodulation circuits of the invention for transmission of data and energy across the rotary transformer 4 of the invention. Shown in DE 102007060555 A1 is an apparatus for transmission of energy and data by means of a transformer via load-, or frequency modulation across a transformer.

For energy transmission, the principle of the push pull converter is applied, which is switched cyclically by means of a push-pull amplifier 33 between the bifilar wound, two primary coils 17 for effecting reversal. In this way, an alternating magnetic flux is produced in the secondary winding 18 of the radial, rotary transformer 4. Due to the pole reversal of the flux in the primary winding 17 and the secondary winding 18, the radial, rotary transformer 4 of the push pull converter does not require a demagnetizing winding, such as usual in the case of single-ended transformers. The energy supply of the sensor electronics 8 occurs by means of rectification of an alternating signal fed-in by a push-pull amplifier 33 via the radial, rotary transformer 4. The energy transferred via the rotary transformer 4 is converted by voltage supply unit (29) in the sensor electronics (8), which has at least one rectification element (36) and at least one linear voltage regulator (37), into the corresponding supply voltage.

Data transmission from the primary side 6 to the secondary side 7 takes place using a corresponding frequency control unit, respectively oscillator, 30 provided on the primary side 6, via which the working frequency of the rotary transformer 4 is changed according to the frequency shift keying method. For example, two different frequency ranges are produced by the oscillator 30, respectively a logical 1 of 160 kilohertz, and a logical 0 of 320 kilohertz. Oscillator 30 is operated by the primary modulator 27 and switches the push-pull-amplifier 33, which performs the switching of the primary coils 17, corresponding to the specified frequency. The primary modulator 27 of the main electronics 7 is embodied as a push pull end stage, which forms, with the radial, rotary transformer 4 and the push-pull-amplifier 33, a push pull converter. The primary modulator 27 and the oscillator 30 can also be integrated and/or embodied in a microprocessor 31 of the main electronics 7.

Conversely, data transmission from the secondary side 7 to the primary side 6 is by means of load modulation by a secondary modulator 25 on the secondary side 7, whereby detection on the primary side 6 is by means of voltage peaks in the transmission signal. This load changing is detected on the primary side 1 by means of voltage peaks in the transmission signal by a primary demodulator 28, which is embodied, for example, in the form of counter 32, and likewise converted correspondingly into logical signals.

### LIST OF REFERENCE CHARACTERS

1 fill-level measuring device
2 sensor housing
3 stepper motor, servomotor, drive motor
4 radial, rotary transformer
5 secondary side
6 primary side
7 main electronics
8 sensor electronics
9 drive shaft
10 measuring shaft
11 displacement element, float
12 outer cable drum
13 inner cable drum
14 fill substance, medium, liquid
15 container
16 fill level
17 primary winding
18 secondary winding
19 measuring line, measuring wire
20 encoder
21 measuring element, measuring transducer
22 sensor signal lines
23 transmission
24 fieldbus, two-wire line
25 secondary modulator
26 secondary demodulator
27 primary modulator
28 primary demodulator
29 voltage supply
30 oscillator
31 microprocessor, evaluating- and control system
32 counter
33 push-pull amplifier
34 oscillatory circuit
35 comparator
36 rectification element
37 linear voltage regulator
38 ferrite core
39 motor drive signal, motor control signal
40 weight measurement signal
41 position data signal
42 measuring transducer signal
43 driving force
44 motor control electronics
45 control station
46 connecting cables
47 drive unit
48 drum space, drum housing
49 electronics compartment
50 housing

1-11. (canceled)

12. An electromechanical, fill-level, measuring device, comprising:
an outer drum with an outer ring of magnets;
a float, or displacement element, which by means of a wire is connected unwindably at least with said outer drum;
an inner drum with an inner ring of magnets and electromagnetic measuring elements, which ascertain magnetic field displacement between the inner and outer rings of magnets and output a measured value;
a measuring shaft, with which said inner drum is mechanically fixedly connected;
a servomotor with a drive shaft, wherein:
said drive shaft is coupled with said measuring shaft via a transmission;
said servomotor rotates said measuring shaft via said transmission as a function of a control signal ascertained from the difference value of said measuring elements, so that, by relative movement between said outer and inner drums produced by a change of the liquid level to be measured, the difference value is returned to zero and from the rotation of said measuring shaft the current fill level measured value is ascertained;
sensor electronics is arranged on said measuring shaft within said inner drum, and a radial, rotary transformer is embodied on said measuring shaft for transmitting at least the control signals from said sensor electronics to main electronics and for supplying at least said sensor electronics with energy.

13. The electromechanical, fill-level, measuring device as claimed in claim 12, wherein:
said radial, rotary transformer is embodied by a bifilar wound, primary winding and a bifilar wound, secondary winding.

14. The electromechanical, fill-level, measuring device as claimed in claim 12, wherein:
said transmission of the control signal and/or communication signals between said sensor electronics and said main electronics is performed digitally via said radial, rotary transformer by means of frequency shift modulation (FSK).

15. The electromechanical, fill-level, measuring device as claimed in claim 12, wherein:
energy supply of said sensor electronics is by means of rectification of an alternating signal fed via said radial, rotary transformer.

16. The electromechanical, fill-level, measuring device as claimed in claim 14, wherein:
evaluating the difference values of said electromagnetic measuring elements and calculating the control signal are performed in said sensor electronics and digital transmission is provided via said rotary transformer.

17. The electromechanical, fill-level, measuring device as claimed in claim 15, wherein:
said sensor electronics includes at least one secondary demodulator, one secondary modulator and one voltage supply unit.

18. The electromechanical, fill-level, measuring device as claimed in claim 15, wherein:
said main electronics includes at least one primary demodulator, one primary modulator and one oscillator.

19. The electromechanical, fill-level, measuring device as claimed in claim 18, wherein:
said primary modulator and said oscillator are integrated and/or embodied in a microprocessor of said main electronics.

20. The electromechanical, fill-level, measuring device as claimed in claim 18, wherein:
said primary demodulator is embodied in said main electronics as a counter.

21. The electromechanical, fill-level, measuring device as claimed in claim 18, wherein:
said primary modulator of said main electronics is embodied as a push pull end stage, which is embodied with said radial, rotary transformer and said push-pull-amplifier as a push pull converter.

22. The electromechanical, fill-level, measuring device as claimed in claim 17, wherein:
said secondary demodulator is embodied in said sensor electronics at least as an oscillatory circuit with a comparator; and
said voltage supply unit in said sensor electronics includes at least one rectification element and at least one linear regulator.
